(19) United States
(12) Patent Application Publication
(10) Pub. No.: US 2014/0078895 A1
(43) Pub. Date: Mar. 20, 2014

(54) PATH COMPUTATION OF WORKING AND RECOVERY PATHS

(71) Applicants: Paola Iovanna, Roma (IT); Giulio Bottari, Livorno (IT); Fabio Ubaldi, Perugia (IT)

(72) Inventors: Paola Iovanna, Roma (IT); Giulio Bottari, Livorno (IT); Fabio Ubaldi, Perugia (IT)

(73) Assignee: Telefonaktiebolaget L M Ericsson (publ), Stockholm (SE)

(21) Appl. No.: 14/002,082

(22) PCT Filed: Apr. 15, 2011
(86) PCT No.: PCT/EP2011/056008

§ 371 Date: Dec. 4, 2013

(30) Foreign Application Priority Data
Feb. 28, 2011 (EP) 11156137.9

(51) Int. Cl. H04L 12/24

(52) U.S. Cl. CPC H04L 41/0668
USPC 370/228

(57) ABSTRACT

Computing working paths and recovery paths in a telecommunications network having nodes capable of supporting different recovery schemes, is based on traffic demands having an indication of a desired recovery service level, for that demand. A path computation is carried out to select a working path through the network for each of the traffic demands and to select which of the different recovery schemes to use according to the service level. The selected working paths and their associated recovery schemes are then set up in the network. By leaving the selection of the recovery scheme to the path computation stage, network resources can be used more efficiently, and operators can specify resiliency in terms of needs rather than in terms of the technology of the network. Thus operators can be insulated from the detailed knowledge of the network.

### TECHNICAL FIELD

This invention relates to methods of computing working paths in a telecommunications network, to path computation engines, and to corresponding computer programs and telecommunications networks.

### BACKGROUND

Routing is the process of finding a suitable route for transmitting traffic between an ingress node and an egress node. Routing is driven by an objective function and can be subject to a set of constraints. Constraint-based path computation is a strategic component of traffic engineering in networks supported by a GMPLS control plane; the outcome of the path computation is the path that the traffic shall follow from the source to the destination. Signaling will be activated on such path. In traditional networks, resiliency was provided using 1+1 protection schemes: service providers needed to reserve up to 50 percent of their network capacity for full service recovery according to a forecast traffic matrix. This involves hardware redundancy in order to deal with failure events. With the current traffic explosion, such a level of redundancy cannot be maintained in most of the traffic scenario, essentially for economic considerations.

The GMPLS control plane can be used to support an alternative and more efficient approach: rather than reserving dedicated and pre-computed alternative paths for each connection, control plane can compute and configure restoration routes using a shared pool of excess capacity (“shared mesh restoration” concept). This can handle events that are difficult to manage with traditional approach such as multiple-failures, bandwidth on-demand.

One advantage is that networks can now effectively use meshed connectivity. Another advantage is that traffic can be recovered from multiple failures. Finally, fewer network resources are necessary to assure resilience.

When a network includes multiple technologies (e.g. packet, SDH, OTN, photonic) the recovery can be provided using one of the available layers or using multiple layer concurrently. This additional degree of freedom enables service providers to more fully utilize their network for revenue-producing traffic rather than reserving an excessive amount of bandwidth for restoration.

The establishment of a new connection is formalized by defining a “traffic demand”. A traffic demand is a set of information including the ingress node, the egress node, the required bandwidth and additional parameters. A list of traffic demands, the traffic matrix, is generated from a user interface or by a provisioning mechanism from another network.

In existing practice, the recovery schemes are assigned a priori based on the specific technology of the data plane. In the case of carrier class traffic it is assumed that the recovery schemes that the specific technology is able to provide will be assigned. For example in an SDH network a SubNetwork Connection Protection (SNCP) protection or a Revertive On-The-Fly (R-OTF) could be used. In a WSON network it could be an OSNCP Protection or a Protection+Restoration scheme.

Each scheme has a particular failure reaction time (from milliseconds to minutes for example), a particular capability in terms of number of simultaneous recovered failures (from 1 to multiple), an amount of required hardware resources, an availability figure (time in which the traffic is lost/total time) and so on.

In addition, End-to-End and local recovery could be provided. According to specific technology the two different recovery types could meet different requirements. For example in the case of WSON networks based on OOO (All optical switching realized by WSS) technology, due to switching time, transmission impairments, and node constraints (e.g. color and direction), local recovery could not be applicable.

Due to such previous reasons, existing path computation methods have as input the actual recovery schemes.

### SUMMARY

An object of the invention is to provide improved apparatus or methods. According to a first aspect, the invention provides:

A method of computing working paths and recovery paths in a telecommunications network having nodes capable of supporting different recovery schemes, by receiving one or more traffic demands, each demand having an indication of a desired recovery service level, for recovery of the traffic of that demand, and carrying out a path computation to select a working path through the network for each of the traffic demands and to select which of the different recovery schemes to use according to the service level. Then the selected working paths and their associated recovery schemes can be set up in the network.

By leaving the selection of the recovery scheme to the path computation stage, rather than selecting before path computation, the network resources can be used more efficiently, and operators can specify the resiliency needs of the traffic in terms of their needs rather than in terms of the technology of the network. Thus operators can be insulated from the detailed knowledge of the network as would be needed if the traffic demand needs to indicate a specific recovery scheme to be used.

Another aspect of the invention can provide a computer program stored on a computer readable medium and having instructions which when executed by a processor cause the processor to carry out the method.

Another aspect of the invention can provide a path computation engine for computing working paths and recovery paths in a telecommunications network having nodes capable of supporting different recovery schemes, the computation engine having an input for receiving one or more traffic demands, each demand having an indication of a desired recovery service level, for recovery of the traffic of that demand, a store for storing descriptions of a number of different recovery schemes, and a processor for carrying out a path computation to select a working path through the network for each of the traffic demands and to select which of the different recovery schemes to use according to the desired recovery service level, and according to the descriptions. An interface is provided to the nodes of the network to enable an indication of the selected working paths and their associated recovery schemes to be passed to the network to cause them to be set up.

Another aspect of the invention can provide a telecommunications network having a number of nodes and a path computation engine as set out above.

Any additional features can be added to these aspects, or disclaimed from them, and some are described in more detail below. Any of the additional features can be combined together and combined with any of the aspects. Other effects and consequences will be apparent to those skilled in the art, especially over compared to other prior art. Numerous variations and modifications can be made without departing from the claims of the present invention. Therefore, it should be clearly understood that the form of the present invention is illustrative only and is not intended to limit the scope of the present invention.

### BRIEF DESCRIPTION OF THE DRAWINGS

How the present invention may be put into effect will now be described by way of example with reference to the appended drawings, in which:

FIG. 1 shows a schematic view of an embodiment,

FIG. 2 shows a series of steps according to an embodiment,

FIG. 3 shows a series of steps according to another embodiment,

FIG. 4 shows a schematic view of another embodiment, and

FIG. 5 shows a schematic view of a network having multi layer nodes and a path computation engine according to another embodiment.

### DETAILED DESCRIPTION

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes.

Definitions

Where the term “comprising” is used in the present description and claims, it does not exclude other elements or steps. Where an indefinite or definite article is used when referring to a singular noun e.g. “a” or “an”, “the”, this includes a plural of that noun unless something else is specifically stated.

The term “comprising”, used in the claims, should not be interpreted as being restricted to the means listed thereafter; it does not exclude other elements or steps.

Elements or parts of the described nodes or networks may comprise logic encoded in media for performing any kind of information processing. Logic may comprise software encoded in a disk or other computer-readable medium and/or instructions encoded in an application specific integrated circuit (ASIC), field programmable gate array (FPGA), or other processor or hardware.

References to nodes can encompass any kind of switching node, not limited to the types described, not limited to any level of integration, or size or bandwidth or bit rate and so on.

References to software can encompass any type of programs in any language executable directly or indirectly on processing hardware.

References to hardware, processing hardware or circuitry can encompass any kind of logic or analog circuitry, integrated to any degree, and not limited to general purpose processors, digital signal processors, ASICs, FPGAs, discrete components or logic and so on.

References to interfaces can encompass any kind of interface between different programs or different optical paths or electrical circuits, including a physical port or portion of a physical port, one or more wavelengths of a wavelength multiplexed interface, one or more time slots of a time division multiplexed interface, one or more packets or connections at a packet based or connection based interface and so on.

References to layers can encompass optical layers, electrical layers, optical transport network (OTN) layers, packet layers and so on, and are not intended to exclude the possibility of having multiple different technologies within the same layer. References to recovery are intended to encompass both protection and restoration and can be applied at various levels in the network, including for example local (span), segment, and/or end-to-end recovery as defined in RFC 4427 “Recovery (Protection and Restoration) Terminology for Generalized Multi-Protocol Label Switching (GMPLS)” section 4. Recovery can encompass many types of recovery scheme including at least those set out in RFC 4427 section 4.6 for the case of LSPs.

### ABBREVIATIONS

CAPEX CAPital EXpenditure

IETF Internet Engineering Task Force

GMPLS Generalized MultiProtocol Label Switching

OTN Optical Transport Network

PCE Path Computation Element

SNCP SubNetwork Connection Protection

TCO Total Cost of Ownership

WSON Wavelength Switched Optical Network

Introduction

By way of introduction to the embodiments, some issues with conventional designs will be explained.

In a multi-layer scenario, it can be difficult to define a-priori the recovery scheme that, in association with a traffic demand, provides the desired level of resiliency at the lower cost. For example, if multiple data flows should be required between two end nodes, it could be convenient to groom them all and protect the bulk at the optical layer. Non-groomable data flows (e.g. directed to different destinations) could be protected at the packet layer.

In case of multiple failures, it could be planned to recover the first failure at the optical layer and the second failure at the packet layer. A third failure could be left to an on the fly approach.

Many networks have a GMPLS control plane, which when used in a multi-layer scenario, is the enabler of intelligent path computation solutions and is also able to perform grooming to better optimize resource usage. When the recovery scheme is selected a priori, also the grooming criterion is implicitly defined. This means an opportunity is missed to take into account the best grooming option for the given network and traffic pattern. In this case the multi layer advantages are not exploited at their best and the optimum is not achieved.

The multi-layer landscape requires a way to find the best possible recovery scheme fully exploiting the rich portfolio of recovery options and ensuring to the customer that its traffic requirements are served minimizing the Total Cost of Ownership (TCO)

In addition, a traffic demand could span multiple domains (operator/vendor autonomous systems), potentially having different technology and policies. In this case the definition of the best recovery scheme could be challenging, if not impossible, a priori.

In existing practice the traffic demands can include a desired recovery scheme or schemes to be activated in case of link or node failures. Required schemes could be for example “Permanent 1+1”, “1+1 protection+restoration”, “1+1 protection”, “Ring protection”, “Restoration”, and no protection at all. Sometimes additional attributes are required by operators in case of restoration: pre-computation of the recovery path, pre-planning, dynamic behavior, reversibility, on the fly and so on. If this is specified by the operator for each traffic demand it implies considerable knowledge of the network and the current state of occupation of resources to enable an optimal choice to be made, which is impractical.

Introduction to Features of Embodiments:

To address at least some of these considerations, embodiments of the invention can involve selecting from the possible recovery schemes during path computation, so that the advantages of multi-layer routing can be better exploited. This can also allow the operator to specify just desired service parameters of the recovery in the traffic demand instead of explicitly specifying a recovery scheme.

The proposed ideas can be applied to any multi-layer, or multi-technology network or any other type of network where multiple, alternative, recovery schemes are available. By considering the required features of the offered traffic (end nodes, bandwidth, quality parameters), an optimal combination of working paths and recovery scheme can be automatically and dynamically selected.

Some Additional Features:

Any other features can be added to the various aspects of the invention and some are described in more detail below.

The nodes can comprise nodes operable at different layers of a multilayer network, and the different recovery schemes can comprise schemes operating at the different layers. This provides more options for recovery but more complexity, thus there is more benefit in insulating the operator from this complexity.

The different recovery schemes can use any one or more of packet switching, circuit switching, optical switching a packet layer recovery scheme and an optical layer recovery scheme. These are commercially useful layers which can provide differing service levels.

The method can have the preliminary step of providing a number of templates each for a different type of recovery scheme according to topology and capabilities of the nodes, the templates having fields capable of holding values for service level attributes. This can help enable the recovery schemes to be represented in a way which facilitates selection by service level.

The method can have the further preliminary step of generating descriptions of technology and topology specific recovery schemes based on the templates by assigning values for the service level attributes according to a topology of the network and technology capabilities of the nodes. This can help complete the descriptions of the recovery schemes to enable their selection by service level.

The step of selecting the recovery scheme can comprise selecting a subset of recovery schemes capable of meeting the desired recovery service level of the traffic demand.

There can be a step of carrying out a routing algorithm to select a combination of working path and recovery scheme according to the traffic demand, the desired recovery service level, and according to the descriptions of the recovery schemes. This can help enable the best combination to be found.

The recovery service level attributes can comprising any one or more of; recovery time, number of simultaneous failures handled, availability, bandwidth, and required hardware resources.

The path computation can comprise selecting how to aggregate paths for the recovery schemes for different ones of the traffic demands.

Path computation

Path computation can encompass either off-line computation during path provisioning or on-line during dynamic routing, or at both times. Both can be complex tasks and sometimes it is not enough to select the shortest path to maximize the network resources usage and reduce capex (capital expenditure). Instead longer paths are selected in certain traffic conditions because the performance in terms of resource optimization is better than always using just the shortest available path.

Path computation is needed in many different types of network. An example is the Internet, which is a conglomeration of Autonomous Systems (AS) or domains that define the administrative authority and the routing policies of different organizations. These domains consist of routers that run Interior Gateway Protocols (IGPs) such as

Routing Information Protocol (RIP), Enhanced Interior Gateway Routing Protocol (EIGRP), Open Shortest Path First (OSPF), and Intermediate System-to -Intermediate System (IS-IS) within their boundaries.

These routing protocols define how routers determine their ‘map’ of the network and from which they can compute the shortest path to a destination, allowing routing to be a largely automatic process. However, the shortest path is not always the fastest or the best. Traffic Engineering (TE) is the process where data is routed through the network according to the availability of resources and the current and expected traffic. The required quality of service (QoS) can also be factored into this process. Traffic Engineering may be under the control of operators whereby they monitor the state of the network and route the traffic, or provision additional resources, to compensate for problems as they arise. Alternatively, Traffic Engineering may be automated. Traffic Engineering helps the network provider make the best use of available resources, spreading the load over the layer 2 links, and allowing some links to be reserved for certain classes of traffic or for particular customers. Technologies such as Multi-Protocol Label Switching (MPLS) and its extensions (i.e. GMPLS, MPLS_TP), provide efficient TE solutions within a single domain thanks to their connection oriented nature, to minimize costs.

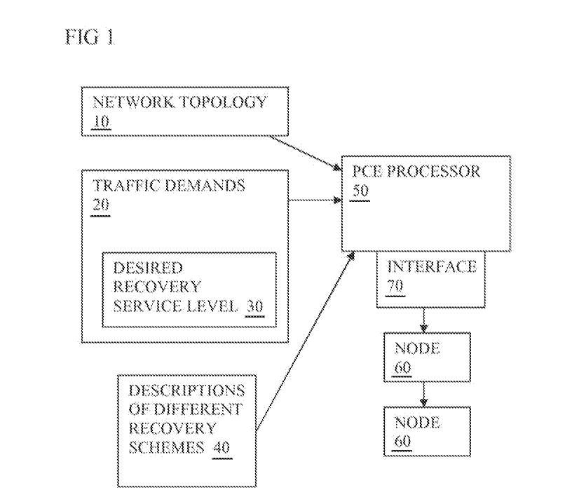

FIG. 1, Schematic View of First Embodiment

FIG. 1 shows a path computation engine processor 50 coupled to receive various inputs including network topology information from a store 10, and traffic demands 20 indicating a desired recovery service level 30. Descriptions of different recovery schemes 40 are also input. The PCE processor has an interface 70 to feed outputs such as working paths and recovery paths or other recovery information to nodes 60 of the network. Each of the parts shown can be implemented in various ways. The desired recovery service level can be a high level description of a service level without specifying which of the possible recovery schemes is to be used. This could be described in various different ways. For example, according to operator policy it could be something like gold, silver, bronze, best effort, MEF (Metro Ethernet Forum) services. It could describe one or more characteristics such as availability, number of simultaneous faults handled, time to set up alternative path and so on.

Desired recovery service level 30 could represent the service parameters (e.g. delay, latency, etc directly included in the demand or implied by the service type such as video, voice, real time, etc.), the SLA (service level agreement) according to the policy assigned by the operators to each service (for example, given two real-time services, one could be sold as Gold, another one as Bronze, and their recovery schemes could have different requirements). Path computation engines may be arranged to handle both traditional traffic demands specifying a recovery type, and traffic demands which specify a desired service level as described above, which leave the engine to determine the appropriate recovery type.

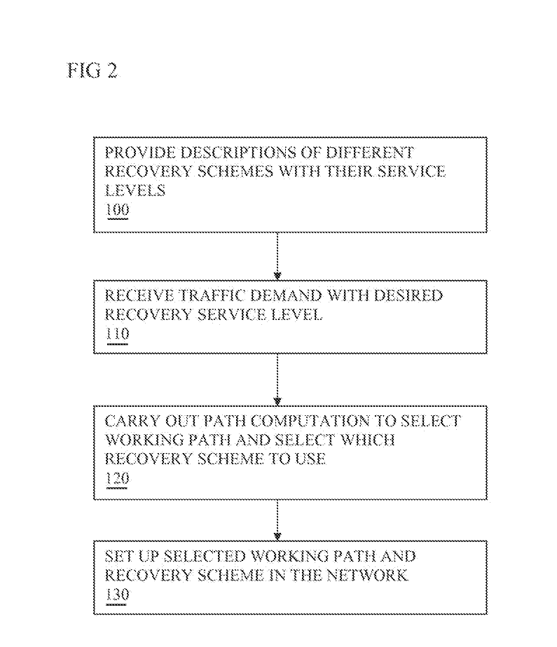

FIG. 2, Method According to an Embodiment

FIG. 2 shows steps according to an embodiment. Descriptions of different recovery schemes and their service levels are provided at step 100. A traffic demand is received at step 110, indicating a desired recovery service level. A path computation is carried out at step 120 to select a working path and to select which recovery scheme to use. The selected working path and selected recovery scheme are set up in the network at step 130.

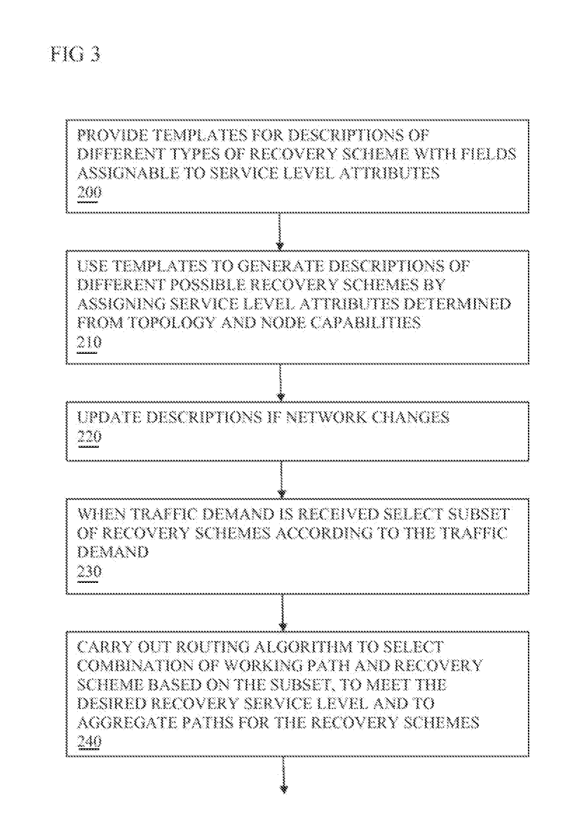

FIG. 3, Method According to Another Embodiment

FIG. 3 shows steps according to another embodiment. Templates are provided at step 200 for descriptions of different types of recovery scheme with fields assignable to values of different service level attributes. At step 210 the templates are filled in by assigning values of the service level attributes determined from the topology and the node capabilities, to generate descriptions of the various possible recovery schemes, to form a portfolio of recovery scheme descriptions. As the network changes to add or remove nodes or capacity or capabilities of any sort, these descriptions can be updated.

At step 230, when a traffic demand is received, a subset of the recovery schemes from the portfolio can be selected according to the details of the traffic demand, to select the possible or most likely candidates. At step 240, a routing algorithm is carried out to select a combination of working path and recovery scheme based on the subset, to meet the desired recovery service level and to aggregate paths for the recovery schemes at least.

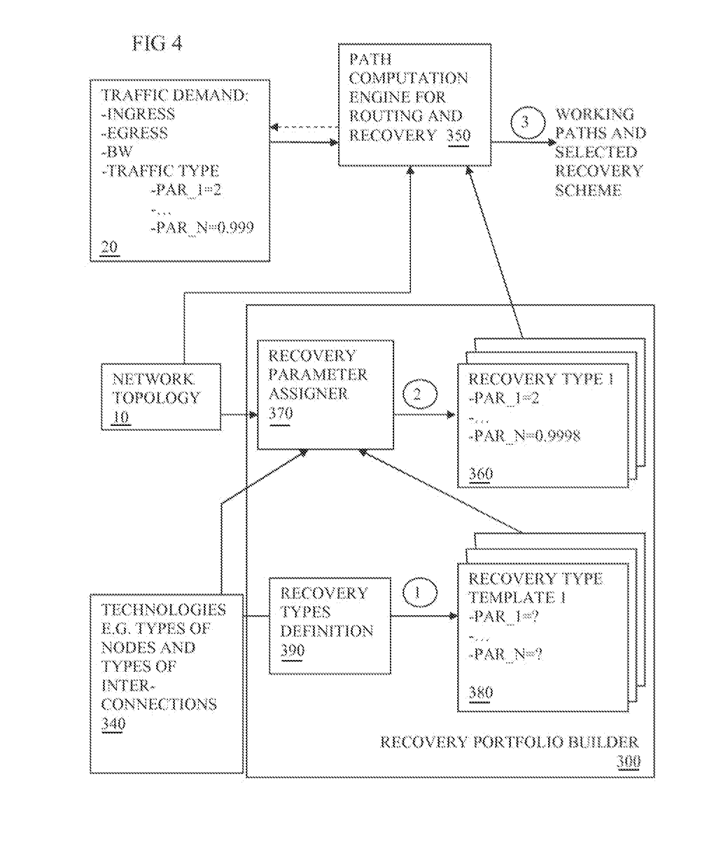

FIG. 4, Schematic View of Another Embodiment,

In FIG. 4, a path computation engine 350 is shown for routing and recovery selection. This outputs working paths and selected recovery scheme for each traffic demand 20. The traffic demands can have details of for example ingress node, egress node, bandwidth and traffic type, in terms of a number of parameters shown as PAR_1 to PAR_N. with example values. The PCE also has inputs from a network topology store 10, and a recovery portfolio builder 300. This is used to build the portfolio based on inputs of the topology and the technologies 340, such as the types of nodes and types of interconnections. These are fed to a recovery types definition part 390 which generates the recovery type templates 380. These templates have various fields left open to be populated by values for given parameters. A parameter assigner part 370 is used to create the recovery scheme descriptions 360 based on the templates, and fills in the open fields based on information from the network topology and the technologies information. Steps 1-3 are located and labeled in FIG. 4 relating to operation of an example of this embodiment and will now be described in more detail. Many variations are possible.

Step I—Recovery Types Definition

In a first step of the method, the Technologies involved in the network are considered. This includes the consideration of the types of node (single layer nodes, multi layer integrated nodes), of the involved technologies (IP/MPLS, Ethernet, SDH, OTN, OOO WDM, OEO WDM . . . ), of the way in which the nodes can be interconnected (in a mesh, in a ring, in technology homogeneous clouds . . . ).

All this information is given as input to a Recovery Types Definition (RTD) module 390. This module defines the portfolio of recovery schemes which could be activated according to the considered technologies. The output of the module is a list of recovery schemes.

The schemes defined by the RTD have a list of predefined parameters (also called attributes). Possible attributes are for example:
Recovery time (e.g. 50 ms)
Nr. of simultaneous failures managed by the scheme (e.g. 2)
Availability (e.g. “5 nines”)
Required HW Resources (e.g. port number)

Step II—Recovery Types Parameters

The purpose of the second step is to assign a value to each parameter of each of the recovery schemes defined in the first step. A module Recovery Types Parameters (RTP) is in charge of the required estimations. RTP receives in input the list of recovery schemes (the output of RTD), the information about the Technologies (this is for example necessary to define the switching time), and the topology of the considered network.

Note that the definition of the values to be assigned to the parameters is not topology independent. The assignment of the availability values, for example, may require running preliminary simulations on the network topology, on which the traffic will be routed.

As an output of the RTP, each of the recovery schemes defined by the RTD, has been characterized with technology and topology dependent values. The recovery portfolio is now defined.

Step III—Routing and Recovery Selector

Consider now a traffic demand: a traffic request is submitted to the Path Computation Element (PCE) to be routed across the given network topology from a source node to a destination node. Such traffic demand can be defined in terms of end nodes (ingress and egress), of required bandwidth, and of traffic type. The traffic type can be the key to the selection of the recovery scheme, among the schemes contained in the portfolio, which best fit the client requirements, as the traffic type will indicate the recovery service level.

The routing engine receives as input the traffic demand and the network topology. The routing task is carried on and the best route and the corresponding recovery scheme are selected. Multiple routes could be required according to the recovery scheme.

Note that traffic demands spanning from a node A to node B, having the same required service level, could be served using different recovery schemes because multiple recovery schemes in the portfolio, could satisfy a given service level.

If no recovery schemes can satisfy the requirements, the traffic demand is blocked (as shown by a dashed line in FIG. 4 Error! Reference source not found.).

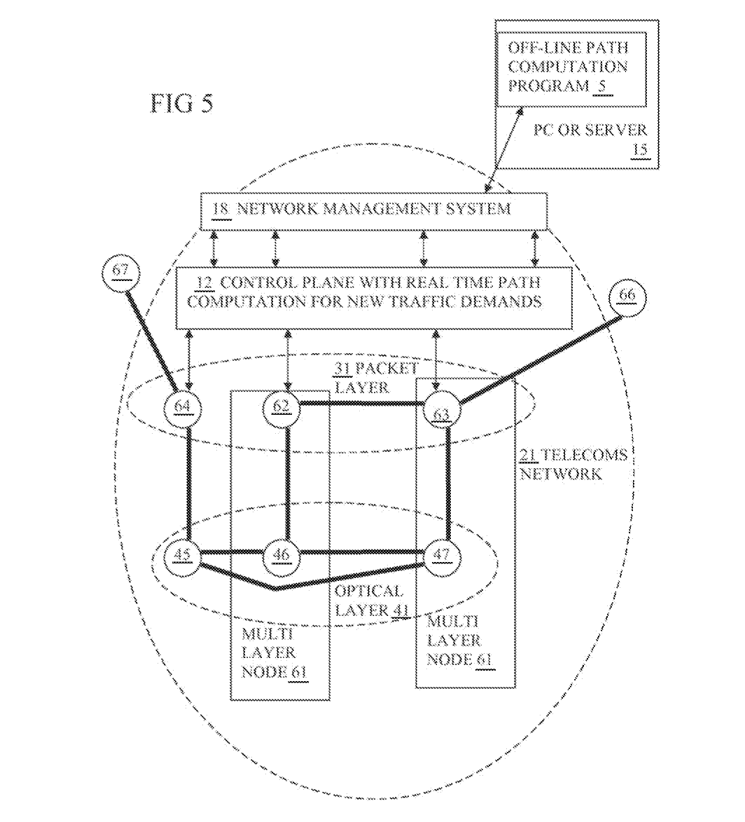

FIG. 5, Schematic View of an Example Network Having Multilayer Nodes

FIG. 5 shows an overview of a network 21 having a number of switching nodes in an electrical domain packet layer 31 and an optical layer 41. A network management system 18 is coupled to a control plane 12. This control plane can be implemented in a centralized or distributed manner as would be known to those skilled in the art. The control plane can undertake path selection in the form of dynamic routing in real time for new traffic requests. The control plane is coupled to switching nodes which can be in the packet layer 31 or the optical layer 41. Some nodes can be hybrid nodes also called multilayer nodes 61, having switching in both layers. A number of links between nodes are shown, a typical network would have many more. A traffic requester 67 outside the network could be an interface from a corporate intranet, or a user terminal for example, requesting traffic from a traffic source such as a remote server. The request can be managed by the network management system, or can be handled directly by the ingress node, in this case switch 64. There are a number of possible paths between the source 67 and the destination 66, passing through packet switches 64, 62 and 63, and optical switches 45, 46 and 47. The path computation can be extended to cover the packet layer and cover more than two layers for example.

Path computation can be carried out either dynamically by a path computation element included in the control plane 12, or off line by an off line path computation program 5 shown running on a computer PC 15 outside the network, and used either for path provisioning during network design before installation, or for determining how best to upgrade the network by providing new capacity. If the path computation is carried out externally to the ingress node, then the requesting entity or the ingress node needs to pass all the necessary information to the external part.

The multilayer nodes can for example be implemented by a Packet-Opto hybrid node that performs adaptation between MPLS-TP technology (i.e. PSC layer) and WSON (i.e. LSC layer). The Packet-Opto node is a hybrid node composed by a double switching capability, that is, a Packet Switching Capability (PSC) and Lambda Switching Capability (LSC). The optical layer LSC can be constituted by an OEO ROADM (Optical-Electrical-Optical Regen-Optical—Add-Drop-Multiplexer), in which the routing of the wavelength signals coming from the transport network is performed, without any limitation due to physical impairments. Thanks to the OEO conversion, the node can be considered to be both colorless and directionless. A controller for the node can be implemented by a conventional processor and appropriate software.

In operation, the path computation element can compute paths using a model of the network. This is one way to implement path computation, others can be envisaged. A model of the network can be provided or built up, having each choice of traffic aggregation modeled, and a representation of each port or sub-port and so on. Also, current information on available capacity and costs can be assigned to each link. This can involve finding information from the nodes, or predetermined or predicted information can be assigned. There can be weighting of links according to congestion level and other criteria.

When a traffic request is received, if the request has a specified bandwidth and quality of service, then it may be appropriate to allow only links which have at least that bandwidth and quality of service available. The quality of service might be expressed in terms of reliability, availability of recovery by protection or restoration, delay parameters such as maximum delay or delay variation, and so on. Then a graph search algorithm such as Dijkstra or other known algorithm can be applied to compare the costs of alternative links to find a lowest cost path to nodes successively further away from a starting node, until the destination node is reached. Other algorithms can include peer to peer type routing algorithms for example.

The selected lowest cost path through the virtual links of the model, is converted into a path list in terms of actual nodes and ports and aggregation information suitable for the actual network. This path can now be set up in the network, for example by sending the path information to the ingress node for it to send messages along the path if using the known RSVP protocol. This can involve sending a first message to the nodes requesting they reserve resources, and then a second message is returned from the egress node requesting the reserved resources be used to set up the path. Of course this can be implemented in other ways using other protocols.

Concluding Remarks

The following consequences can arise from at least some of the embodiments :
The method can give to operators a more accurate way to express its resiliency needs with the assurance to have a technology and network tailored recovery selection.
The operator is not required to know “a priori” the recovery scheme portfolio but just the desired service requirements.
The method can allow better optimizing of the use of the network resources (CAPEX reduction).
The method can be integrated in existing PCE scenarios, both off line and on line. It can be fully compatible with all PCE methods, policies, implementations.
The method can be applied both to single-layer or multi-layer scenario.

Other variations and embodiments can be envisaged within the claims.

1. A method of computing working paths and recovery paths in a telecommunications network having nodes capable of supporting different recovery schemes, the method comprising:
receiving one or more traffic demands, each demand having an indication of a desired recovery service level, for recovery of the traffic of that demand,
carrying out a path computation to select a working path through the network for each of the traffic demands and to select which of the different recovery schemes to use according to the service level, and
setting up the selected working paths and their associated recovery schemes in the network.

2. The method of claim 1, wherein the telecommunications network comprises a multilayer network, wherein the nodes are operable at different layers of the multilayer network, and wherein the different recovery schemes comprise schemes operating at the different layers.

3. The method of claim 2, wherein the different recovery schemes use one or more of packet switching, circuit switching, and optical switching.

4. The method of claim 1, further comprising:
providing a number of templates each for a different type of recovery scheme according to a topology of the network and technology capabilities of the nodes, the templates having fields capable of holding values for service level attributes.

5. The method of claim 4, further comprising:
generating descriptions of technology and topology specific recovery schemes based on the templates by assigning values for the service level attributes according to the topology of the network and the technology capabilities of the nodes.

6. The method of claim 5, wherein the of selecting the recovery scheme comprises selecting a subset of recovery schemes capable of meeting the desired recovery service level of the traffic demand.

7. The method of claim 6, further comprising
carrying out a routing algorithm to select a combination of working path and recovery scheme according to the traffic demand, the desired recovery service level, and to the descriptions of the recovery schemes.

8. The method of claim 1, wherein the desired recovery service level attributes each comprise one or more of:
a recovery time,
a number of simultaneous failures handled,
an availability,
a bandwidth, and
a set of required hardware resources.

9. The method of claim 1, wherein the path computation comprises selecting how to aggregate paths for the recovery schemes for different ones of the traffic demands.

10. (canceled)

11. A path computation engine for computing working paths and recovery paths in a telecommunications network having nodes capable of supporting different recovery schemes, the computation engine comprising:
an input for receiving one or more traffic demands, each demand having an indication of a desired recovery service level for recovery of the traffic of that demand,
a store for storing descriptions of a number of different recovery schemes,
a processor for carrying out a path computation to select a working path through the network for each of the traffic demands and to select which of the different recovery schemes to use according to the desired recovery service level and according to the descriptions, and
an interface to the nodes of the network to enable an indication of the selected working paths and their associated recovery schemes to be passed to the network to cause them to be set up.

12. The engine of claim 11, wherein the telecommunications network comprises a multilayer network, wherein the nodes are operable at different layers of the multilayer network, and wherein the different recovery schemes comprise comprising schemes operating at the different layers.

13. The engine of claim 12, wherein the different recovery schemes are arranged to use one or more of packet switching, circuit switching, and optical switching.

14. The engine of claim 11, wherein the engine is further arranged to generate the stored descriptions by providing a number of templates each for a different type of recovery scheme according to a topology of the network and technology capabilities of the technologies used by the nodes, the templates having fields capable of holding values of service level attributes.

15. The engine of claim 14, wherein the engine is further arranged to generate the descriptions and topology specific recovery schemes based on the templates by filling the fields with values for the service level attributes determined according to the topology of the network and the technology capabilities of the nodes.

16. The engine of claim 14, wherein the processor is arranged to select the recovery scheme by selecting a subset of possible recovery schemes capable of meeting the desired service level of the traffic demand.

17. The engine of claim 16, wherein the processor is further arranged to carry out a routing algorithm to select a combination of working path and recovery scheme according to the traffic demand, according to the desired recovery service level, and the descriptions of the selected recovery schemes.

18. The engine of claim 11, wherein the desired recovery service level attributes each comprise one or more of:
a recovery time,
a number of simultaneous failures handled,
an availability,
a bandwidth, and
a set of required hardware resources.

19. The engine of claim 11, wherein the path computation comprises selecting how to aggregate the recovery schemes for different ones of the traffic demands.

20. (canceled)

21. A non-transitory computer-readable storage medium comprising instructions that, when executed by a processor of a computing device, cause the computing device to perform operations comprising:
receiving one or more traffic demands, each demand having an indication of a desired recovery service level, for recovery of the traffic of that demand;
carrying out a path computation to select a working path through the network for each of the traffic demands and to select which of the different recovery schemes to use according to the service level; and
setting up the selected working paths and their associated recovery schemes in the network.

22. The non-transitory computer-readable storage medium of claim 21, wherein the telecommunications network comprises a multilayer network, wherein the nodes are operable at different layers of the multilayer network, and wherein the different recovery schemes comprise schemes operating at the different layers.
